(19) United States
(12) Patent Application Publication
(10) Pub. No.: US 2010/0208066 A1
(43) Pub. Date: Aug. 19, 2010

(54) IMAGE PROCESSING APPARATUS

(75) Inventor: Tetsuro Yabumoto, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/698,560

(22) Filed: Feb. 2, 2010

(30) Foreign Application Priority Data
Feb. 17, 2009 (JP) 2009-033957

(51) Int. Cl. H04N 7/18

(52) U.S. Cl. 348/143; 348/E07.085

(57) ABSTRACT

An image processing apparatus includes an AFE circuit which repeatedly fetches an object scene image in synchronization with a vertical synchronization signal outputted from an SG. An image-data processing circuit cuts out an object scene image belonging to a cut-out area, out of the object scene image fetched by the AFE circuit, and performs an output process on the cut-out object scene image. A CPU changes a size of the cut-out area in a direction opposite to a fluctuating direction of a magnitude of a frequency of the vertical synchronization signal.

### CROSS REFERENCE OF RELATED APPLICATION

The disclosure of Japanese Patent Application No. 2009-33957, which was filed on Feb. 17, 2009, is incorporated herein by reference.

### BACKGROUND OF THE INVENTION

1. Field of the Invention

The present invention relates to an image processing apparatus. More particularly, the present invention relates to an image processing apparatus, applied to a surveillance camera, which performs a predetermined process on an object scene image repeatedly fetched in synchronization with a reference frequency.

2. Description of the Related Art

According to one example of this type of an apparatus, an imaging element has a line number larger than a line number of a standard television system. Image stabilization is executed by using an excess line that occurs due to an increase in line number: Also, a position of a window used for obtaining optical information is changed according to an image stabilizing amount. Thereby, optical information adapted to a photographing screen is obtained. As a result, it becomes possible to remedy a problem that the whole brightness is changed in spite of the screen being stationary.

However, the above-described apparatus does not assume a fluctuation of a frame rate of the imaging element. Thus, due to the fluctuation of the frame rate, image data is partially failed. As a result, an error image representing the failure may appear on the screen.

### SUMMARY OF THE INVENTION

An image processing apparatus according to the present invention, comprises: a fetcher which repeatedly fetches an object scene image in synchronization with a reference frequency; a cut-out processor which cuts out an object scene image belonging to a cut-out area, out of the object scene image fetched by the fetcher; an outputter which performs an output process on the object scene image cut out by the cut-out processor; and a first changer which changes a size of the cut-out area in a direction opposite to a fluctuating direction of a magnitude of the reference frequency.

Preferably, further comprised is a producer which produces the reference frequency based on one of an external synchronization signal that is synchronized with a commercially available alternating power source and an internal synchronization signal, and the first changer executes a change process when the producer notices the external synchronization signal.

Preferably, further comprised are: a first requester which requests the producer to select the commercially available alternating power source when the magnitude of the reference frequency belongs to a predetermined range; and a second requester which requests the producer to select the internal synchronization signal when the magnitude of the reference frequency deviates from the predetermined range.

Preferably, the outputter includes a second changer which changes the size of the object scene image to a size different depending on the size of the cut-out area.

More preferably, the second changer changes the size of the object scene image in a direction opposite to a change direction of the size of the cut-out area.

Preferably, a scanning manner for the object scene image fetched by the fetcher is equivalent to a progressive scanning manner, and the outputter includes a convertor which converts the scanning manner for the object scene image to an interlace scanning manner.

Preferably, further comprised is an imager which captures a surveillance area, and the fetcher fetches the object scene image outputted from the imager.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of the present invention;

FIG. 2 is a block diagram showing a configuration of one embodiment of the present invention;

FIG. 3 is a block diagram showing one example of a configuration of an SG applied to the embodiment in FIG. 2;

FIG. 4 is a block diagram showing one example of a configuration of an image-data processing circuit applied to the embodiment in FIG. 2;

FIG. 5 is a block diagram showing one portion of an operation of a cut-out circuit applied to the embodiment in FIG. 2;

FIG. 6(A) is an illustrative view showing one example of an operation of a scaler applied to the embodiment in FIG. 2;

FIG. 6(B) is an illustrative view showing another example of the operation of the scaler applied to the embodiment in FIG. 2;

FIG. 6(C) is an illustrative view showing still another example of the operation of the scaler applied to the embodiment in FIG. 2;

FIG. 7(A) is an illustrative view showing one example of image data of a plurality of continuous frames;

FIG. 7(B) is an illustrative view showing one example of image data of an odd-number field;

FIG. 7(C) is an illustrative view showing one example of image data of an even-number field;

FIG. 8 is an illustrative view showing one portion of an operation of the embodiment in FIG. 2;

FIG. 9 is a flowchart showing one portion of an operation of a CPU applied to the embodiment in FIG. 2; and

FIG. 10 is a flowchart showing another portion of the operation of the CPU applied to the embodiment in FIG. 2.

### DETAILED DESCRIPTION OF THE PREFERRED EMBODIMENTS

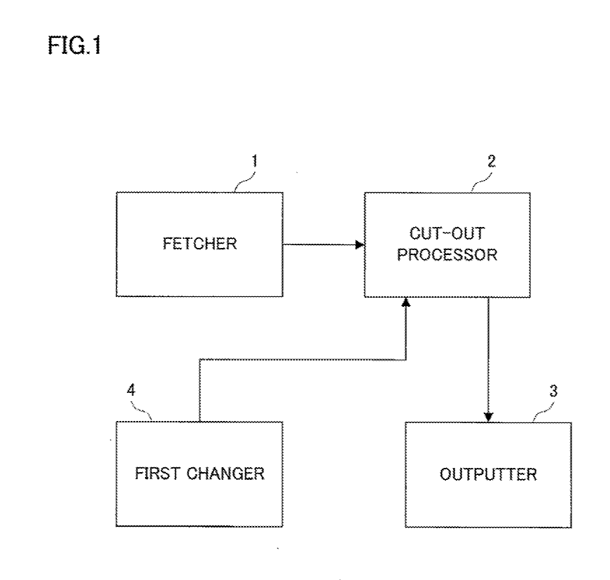

With reference to FIG. 1, an image processing apparatus of the present invention is basically configured as follows: A fetcher 1 repeatedly fetches an object scene image in synchronization with a reference frequency. A cut-out processor 2 cuts out an object scene image belonging to a cut-out area, out of the object scene image fetched by the fetcher 1. An outputter 3 performs an output process on the object scene image cut out by the cut-out processor 2. A first changer 4 changes a size of the cut-out area in a direction opposite to a fluctuating direction of a magnitude of the reference frequency.

A fetching rate for the object scene image increases as the reference frequency increases, and the same decreases as the reference frequency decreases. On the other hand, the size of the cut-out area decreases as the reference frequency increases, and the same increases as the reference frequency decreases. Therefore, the size of the object scene image cut out by the cut-out processor 2 decreases as the number of object scene images fetched by the fetcher 1 increases, and the same increases as the number of object scene images fetched by the fetcher 1 decreases. This enables prevention of a situation where an error image representing a failure of the object scene image appears.

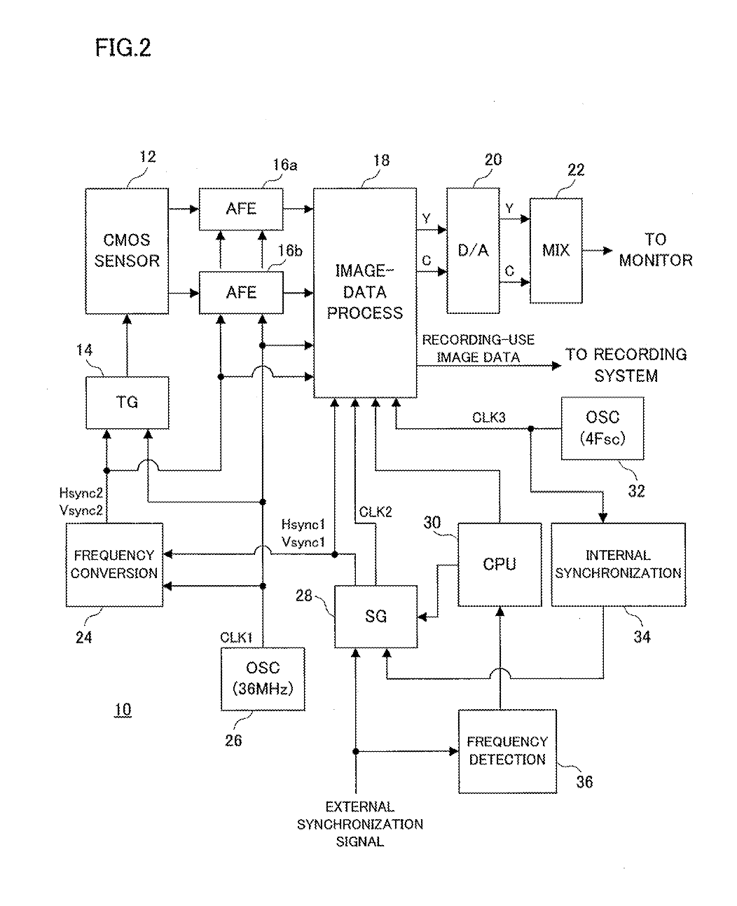

With reference to FIG. 2, a surveillance camera 10 of this embodiment is a surveillance camera adapted to a PAL format, and includes a CMOS sensor 12 which captures a surveillance area. An optical image representing the surveillance area undergoes an optical lens (not shown), and an imaging surface is irradiated with the resultant image. Thereby, electric charges representing the object scene are produced on the imaging surface. An effective area of the imaging surface has horizontal 800 pixels×vertical 600 pixels, and is covered with a primary color filter not shown. Therefore, the electric charges produced by each pixel have any one of color information, i.e., R (Red), G (Green), and B (Blue).

An oscillator 26 generates a clock CLK1 having a frequency of 36 MHz. Moreover, when an external synchronization mode is set, an SG (Signal Generator) 28 generates a horizontal synchronization signal Hsync1, a vertical synchronization signal Vsync1, and a clock CLK2 based on an external synchronization signal that is synchronized with a commercially available power source of 50 Hz. When an internal synchronization mode is set, the SG 28 again generates the horizontal synchronization signal Hsync1, the vertical synchronization signal Vsync1, and the clock CLK2 based on an internal synchronization signal described later.

Due to a fact that the external synchronization signal, which basically has a frequency of 50 Hz, is synchronized with the commercially available power source, if the frequency of the commercially available power source fluctuates, the frequency of the external synchronization signal also fluctuates. A frequency detecting circuit 36 detects the frequency of such an external synchronization signal, and applies a detection result to a CPU 30. The CPU 30 refers to the detection result of the frequency detecting circuit 36 so as to change settings of the SG 28 and an image-data processing circuit 18.

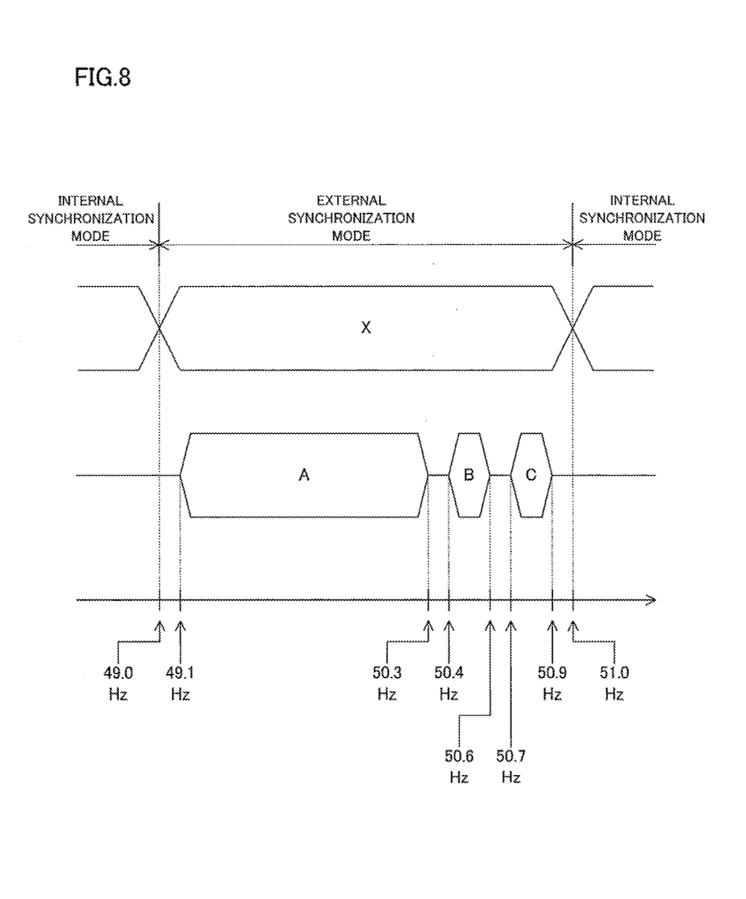

Specifically, the CPU 30 sets a power-source synchronization mode to the SG 28 when the frequency of the external synchronization signal belongs to a range X, i.e., a range of 49.0 Hz to 51.0 Hz shown in FIG. 8. Furthermore, the CPU 30 sets an internal synchronization mode to the SG 28 when the frequency of the external synchronization signal deviates from the range X. It is noted that a change in setting of the image-data processing circuit 18 will be described later.

An oscillator 32 generates a clock CLK3 of which the frequency is four times greater than a color subcarrier frequency Fsc. An internal-synchronization-signal producing circuit 34 produces an internal synchronization signal of which the frequency is 1035 times greater than 4 Fsc based on the clock CLK3 outputted from the oscillator 32, and applies the produced internal synchronization signal to the SG 28.

A frequency converting circuit 24 refers to the clock CLK1 outputted from the oscillator 26 so as to convert the frequencies of the horizontal synchronization signal Hsync1 and the vertical synchronization signal Vsync1 outputted from the SG 28. Thereby, a horizontal synchronization signal Hsync2 and a vertical synchronization signal Vsync2 adapted to frequencies of 36 MHz are produced.

A TG (Timing Generator) 14 drives the CMOS sensor 12 based on the horizontal synchronization signal Hsync2 and the vertical synchronization signal Vsync2 outputted from the frequency converting circuit 24 and the clock CLK1 outputted from the oscillator 26.

The CMOS sensor 12 has a high-luminance-use channel CH1 and a low-luminance-use channel CH2, and its imaging surface is scanned in a progressive scanning manner. As a result, a high-luminance raw image signal that is based on the electric charges produced on the imaging surface is outputted from the channel CH1, and a low-luminance raw image signal that is based on the electric charges produced on the imaging surface is outputted from the channel CH2. Both the outputted raw image signals of the two channels have a frame rate of 50 frame/second.

The high-luminance raw image signal outputted from the channel CH1 undergoes an A/D converting process performed by an AFE (Analog Front End) circuit 16a, and the resultant signal is inputted, as high-luminance raw mage data, into the image-data processing circuit 18. Also, the low-luminance raw image signal outputted from the channel CH2 undergoes an A/D converting process performed by the AFE circuit 16b, and the resultant signal is inputted, as low-luminance raw image data, into the image-data processing circuit 18.

It is noted that also the APE circuits 16a and 16b operate in response to the horizontal synchronization signal Hsync2 and the vertical synchronization signal Vsync2 outputted from the frequency converting circuit 24 and the clock CLK1 outputted from the oscillator 26.

The image-data processing circuit 18 refers to the above-described horizontal synchronization signal Hsync2, vertical synchronization signal Vsync2, and clocks CLK1 to CLK3 so as to perform a predetermined data process on the raw image data inputted from the AFE circuits 16a and 16b. As a result, recording-use image data that complies with an REC 656 standard is outputted toward a recording system not shown, and display-use Y data and C data that are adapted to a PAL format are outputted toward a D/A converter 20.

The D/A converter 20 converts the applied Y data and C data into a Y signal and a C signal, i.e., analog signals. The converted Y signal and C signal are mixed by a mixer 22, and a composite video signal produced thereby is outputted toward a TV monitor (not shown) that is adapted to an NTSC format.

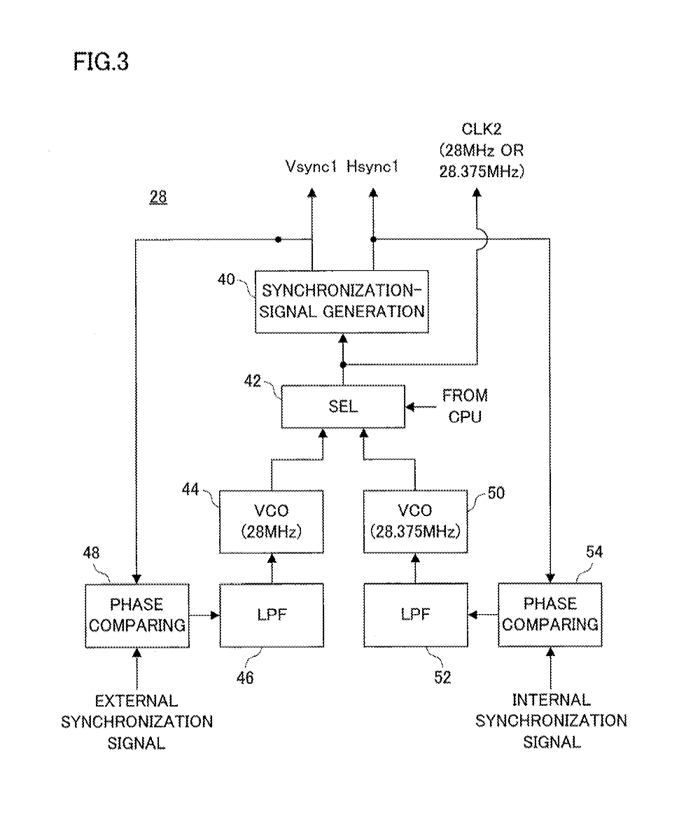

The SG 28 is configured as shown in FIG. 3. A phase comparator 48 compares a phase of the vertical synchronization signal Vsync1 outputted from a synchronization-signal producing circuit 40 with that of the external synchronization signal, and inputs a comparison result into a VCO 44 via an LPF 46. An oscillation frequency of the VCO 44 fluctuates above and below 28 MHz (which acts as a center frequency) with a range of ±2% from the center frequency according to a phase difference between the vertical synchronization signal Vsync1 and the external synchronization signal.

On the other hand, a phase comparator 54 compares a phase of the horizontal synchronization signal Hsync1 outputted from the synchronization-signal producing circuit 40 with that of the internal synchronization signal, and inputs a comparison result into a VCO 50 via an LPF 52. The oscillation frequency of the VCO 50 fluctuates above and below 28.375 MHz (which acts as a center frequency) with a range of ±2% from the center frequency according to a phase difference between the horizontal synchronization signal Hsync1 and the internal synchronization signal.

A selector 42 selects the VCO 44 corresponding to the power-source synchronization mode, and on the other hand, selects the VCO 50 corresponding to the internal synchronization mode. The synchronization-signal producing circuit 40 is inputted an oscillation frequency signal of the selected VCO. Also, the oscillation frequency signal of the VCO selected by the selector 42 is outputted, as the clock CLK2, toward the image-data processing circuit 18. The synchronization-signal producing circuit 40 generates the vertical synchronization signal Vsync1 and the horizontal synchronization signal Hsync1 based on the inputted oscillation frequency signal.

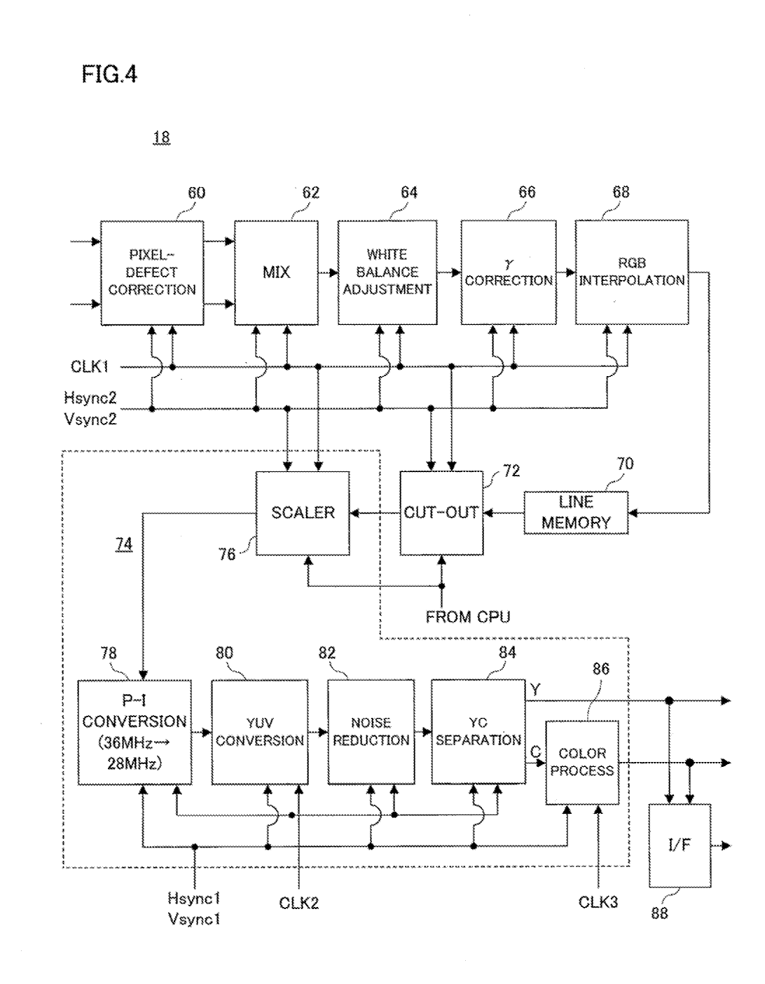

The image-data processing circuit 18 is configured as shown in FIG. 4. The raw image data inputted from the AFE circuits 16a and 16b are subjected to a pixel-defect correcting process by a pixel-defect correcting circuit 60, and thereafter, the resultant data are mixed with each other by a mixer 62. From the mixer 62, raw image data that is integrated into one channel is outputted.

A white balance of the integrated raw image data is adjusted by a white-balance adjusting circuit 64, and a brightness of the raw image data having the adjusted white balance is corrected by a gamma correcting circuit 66. An RGB interpolating circuit 68 performs an interpolating process on the raw image data outputted from the gamma correcting circuit 66, and writes the RGB image data in which each pixel has all the color information, i.e., R, G, and B, into a line memory 70.

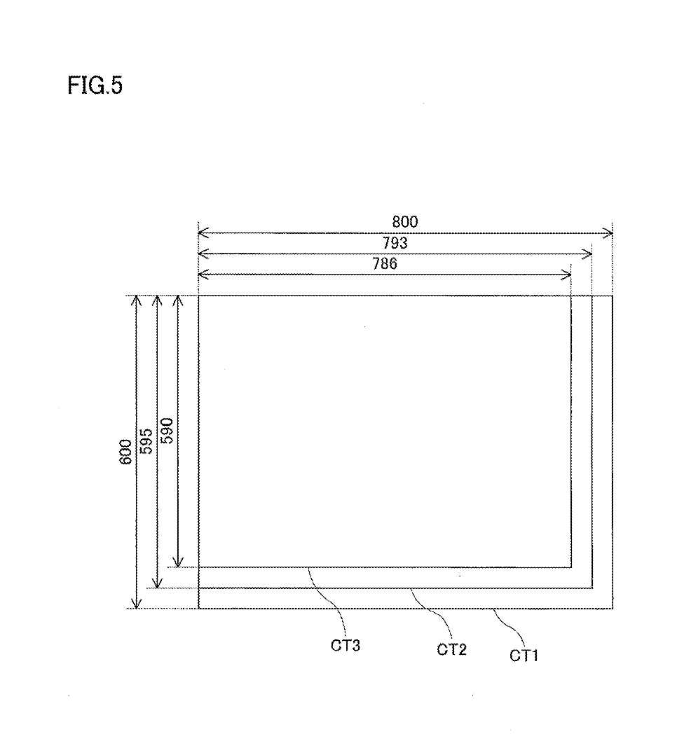

With reference to FIG. 5, a cut-out area CT1 has a size of horizontal 800 pixels×vertical 600 pixels, a cut-out area CT2 has a size of horizontal 793 pixels×vertical 595 pixels, and a cut-out area CT3 has a size of horizontal 786 pixels×vertical 590 pixels. Furthermore, the cut-out areas CT1 to CT3 are allotted to the effective area of the imaging surface in such a manner that apex angles at an upper left are mutually matched.

The CPU 30 sets the cut-out area CT1 to a cut-out circuit 72 when the frequency of the external synchronization signal belongs to a range of 49.1 Hz to 50.3 Hz, i.e., a range A shown in FIG. 8. Furthermore, the CPU 30 sets the cut-out area CT2 to the cut-out circuit 72 when the frequency of the power-source synchronization signal belongs to a range of 50.4 Hz to 50.6 Hz, i.e., a range B shown in FIG. 8. Moreover, the CPU 30 sets the cut-out area CT3 to the cut-out circuit 72 when the frequency of the power-source synchronization signal belongs to a range of 50.7 Hz to 50.9 Hz, i.e., a range C shown in FIG. 8.

The cut-out circuit 72 reads out the RGB image data belonging to the cut-out area set by the CPU 30, out of the RGB image data accommodated in the line memory 70. The read-out RGB image data is applied to a scaler 76 configuring an output processing circuit 74.

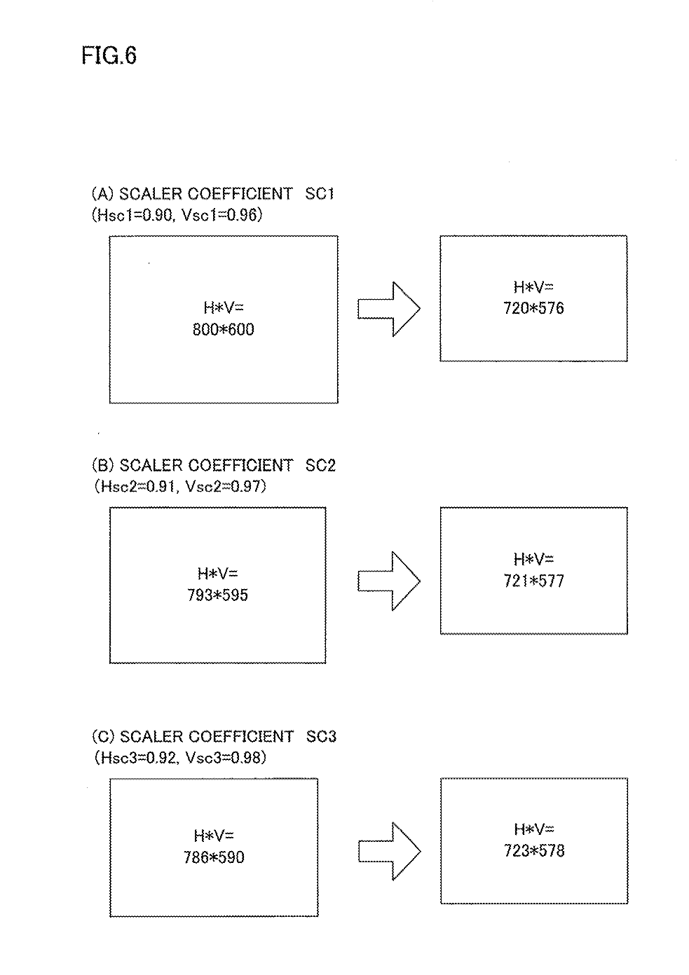

With reference to FIG. 6(A) to FIG. 6(C), a scaler coefficient SC1 is defined by the horizontal coefficient Hsc1 and the vertical coefficient Vsc1, a scaler coefficient SC2 is defined by the horizontal coefficient Hsc2 and the vertical coefficient Vsc2, and a scaler coefficient SC3 is defined by the horizontal coefficient Hsc3 and the vertical coefficient Vsc3. Furthermore, the horizontal coefficient Hsc1 and the vertical coefficient Vsc1 indicate “0.90” and “0.96”, respectively, the horizontal coefficient Hsc2 and the vertical coefficient Vsc2 indicate “0.91” and “0.97”, respectively, and the horizontal coefficient Hsc3 and the vertical coefficient Vsc3 indicate “0.92” and “0.98”, respectively.

The CPU 30 sets the scaler coefficient SC1 to the scaler 76 corresponding to the cut-out area CT1, sets the scaler coefficient SC2 to the scaler 76 corresponding to the cut-out area CT2, and sets the scaler coefficient SC3 to the scaler 76 corresponding to the cut-out area CT3. The scaler 76 executes a zoom process that refers to the scaler coefficient set by the CPU 30, on the RGB image data applied from the cut-out circuit 72.

Therefore, the RGB image data, of horizontal 800 pixels×vertical 600 pixels, belonging to the cut-out area CT1 is converted into RGB image data of horizontal 720 pixels×vertical 576 pixels. Furthermore, the RGB image data, of horizontal 793 pixels×vertical 595 pixels, belonging to the cut-out area CT1 is converted into RGB image data of horizontal 721 pixels×vertical 577 pixels. Moreover, the RGB image data, of horizontal 786 pixels×vertical 590 pixels, belonging to the cut-out area CT1 is converted into RGB image data of horizontal 723 pixels×vertical 578 pixels.

As a result, from the scaler 76, RGB image data of a size that matches or substantially matches a size that is adapted to the PAL format (=horizontal 720 pixels×vertical 576 pixels) is outputted.

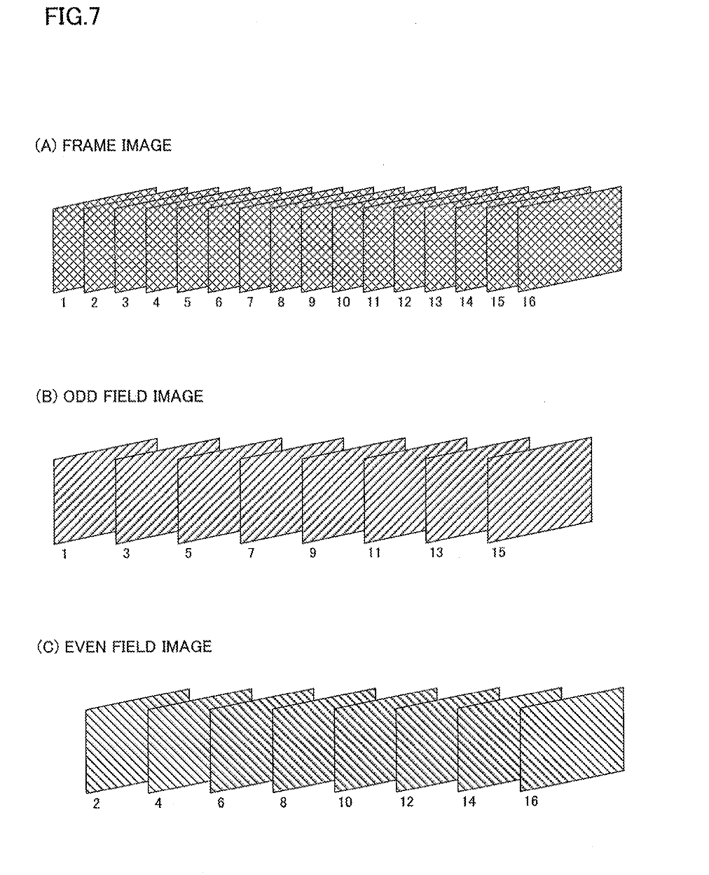

A P-I converting circuit 78 converts the scanning manner for the RGB image data outputted from the scaler 76 from the progressive scanning manner into an interlace scanning manner. Specifically, as shown in FIG. 7(A) to FIG. 7(C), a thinning-out process is performed on linearly interpolated image data at an odd numbered frame so as to create 1 field of linearly interpolated image data having an odd numbered line only, and a thinning-out process is performed on linearly interpolated image data at an even numbered frame so as to create 1 field of linearly interpolated image data having an even numbered line only.

The linearly interpolated image data having the scanning manner thus converted is converted into image data of a YUV format by a YUV converting circuit 80. A noise reduction circuit 82 reduces noise from the converted YUV image data, and a YC separating circuit 84 separates the YUV image data from which the noise is reduced, into Y data and C data (UV data). Out of the separated Y data and C data, the C data is subjected to a predetermined color process in a color processing circuit 86. The Y data and the C data thus obtained are directly outputted toward the D/A converter 20 shown in FIG. 2, and also converted into recording-use image data (that complies with an REC656 standard) by an I/F circuit 88. The converted recording-use image data is outputted toward a recording system.

It is noted that each of the defect correcting circuit 60, the mixer 62, the white-balance adjusting circuit 64, the gamma correcting circuit 66, the RGB interpolating circuit 68, the cut-out circuit 72, and the scaler 74 operates in response to the horizontal synchronization signal Hsync2, the vertical synchronization signal Vsync2, and the clock CLK1. Also, each of the P-I converting circuit 78, the YUV converting circuit 80, the noise reduction circuit 82, and the YC separating circuit 84 operates in response to the horizontal synchronization signal Hsync1, the vertical synchronization signal Vsync1, and the clock CLK2. Moreover, the color processing circuit 86 operates in response to the horizontal synchronization signal Hsync1, the vertical synchronization signal Vsync1, and the clock CLK3.

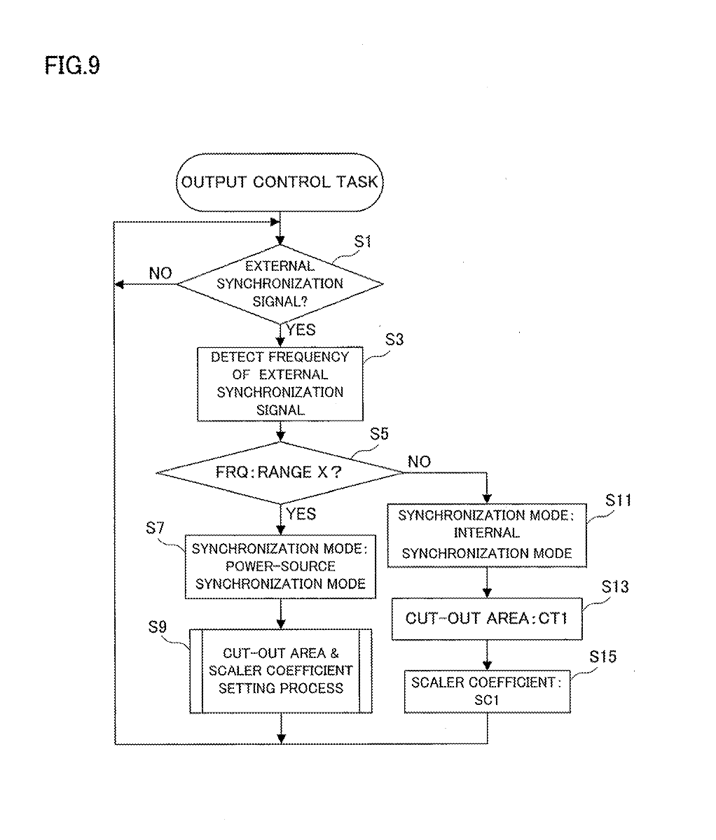

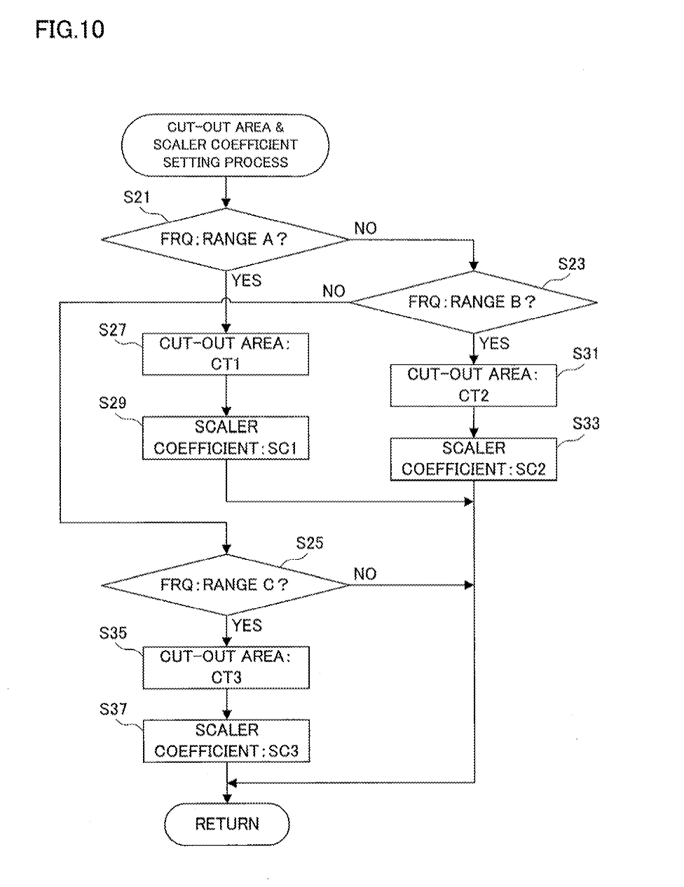

The CPU 30 executes a plurality of tasks, including an output control task shown in FIG. 9 and FIG. 10, in a parallel manner. It is noted that control programs corresponding to these tasks are stored in a flash memory not shown.

With reference to FIG. 9, in a step S1, it is determined whether or not the external synchronization signal is generated. When a determination result is updated from NO to YES, the process advances to a step S3 so as to detect the frequency of the external synchronization signal based on the output of the frequency detecting circuit 36. In a step S5, it is determined whether or not the detected frequency belongs to the range X. When a determination result is YES, the process advances to a step S7, and when the determination result is NO, the process advances to a step S11.

In the step S7, selection of the power-source synchronization mode is requested to the selector 42 shown in FIG. 3. Upon completion of the mode setting, a cut-out area & scaler coefficient setting process is executed in a step S9, and thereafter, the process returns to the step S1. In the step S11, selection of the internal synchronization mode is requested to the selector 42 shown in FIG. 3. In a step S13, the cut-out area CT1 is set to the cut-on circuit 72, and in a step S15, the scaler coefficient SC1 is set to the scaler 76. Upon completion of the process in the step S15, the process returns to the step S1.

The cut-out area & scaler coefficient setting process in the step S9 is executed according to a subroutine shown in FIG. 10.

In a step S21, it is determined whether or not the frequency detected in the step S3 belongs to the range A. In a step S23, it is determined whether or not the frequency detected in the step S3 belongs to the range B. In a step S25, it is determined whether or not the frequency detected in the step S3 belongs to the range C.

When YES is determined in the step S21, the process undergoes processes in steps S27 and S29, and then, the process is returned to a routine at a hierarchical upper level. When YES is determined in the step S23, the process undergoes processes in steps S31 and S33, and then, the process is returned to a routine at a hierarchical upper level. When YES is determined in the step S25, the process undergoes processes in steps S35 and S37, and then, the process is returned to a routine at a hierarchical upper level. When NO is determined in all the steps S21 to S25, the process is directly returned to a routine at a hierarchical upper level.

In the step S27, the cut-out area CT1 is set to the cut-out circuit 72, and in the step S29, the scaler coefficient SC1 is set to the scaler 76. In the step S31, the cut-out area CT2 is set to the cut-out circuit 72, and in the step S33, the scaler coefficient SC2 is set to the scaler 76. In the step S35, the cut-out area CT3 is set to the cut-out circuit 72, and in the step S37, the scaler coefficient SC3 is set to the scaler 76.

As is seen from the above-mentioned description, each of the AFE circuits 16a and 16b repeatedly fetches the object scene image in synchronization with the vertical synchronization signal Vsync2 outputted from the SG 28. The cut-out circuit 72 cuts out the object scene image belonging to the cut-out area, out of the fetched object scene image. The output processing circuit 74 performs an output process on the object scene image cut out by the cut-out circuit 72. The CPU 30 changes the size of the cut-out area in a direction opposite to the fluctuating direction of the magnitude of the frequency of the vertical synchronization signal Vsync2 (S27, S31, and S35).

The fetching rate of the object scene image increases as the frequency of the vertical synchronization signal Vsync2 increases, and the same decreases as the frequency of the vertical synchronization signal Vsync2 decreases. In contrary, the size of the cut-out area decreases as the frequency of the vertical synchronization signal Vsync2 increases, and the same increases as the frequency of the vertical synchronization signal Vsync2 decreases. Therefore, the size of the object scene image cut out by the cut-out circuit 72 decreases as the number of object scene images fetched by the AFE circuits 16a and 16b increases, and the same increases as the number of object scene images fetched by the AFE circuits 16a and 16b decreases. This enables prevention of a situation where the error image representing a failure of the object scene image appears on the outputted image.

It is noted that in this embodiment, it is assumed that a surveillance image is displayed on a TV monitor adapted to the PAL format, and thus, the size of the RGB image data is converted from “horizontal 800 pixels×vertical 600 pixels” into “horizontal 720 pixels×vertical 576 pixels”. However, if the surveillance image is displayed on a TV monitor adapted to an NTSC format, it is needed that the size of the RGB image data is converted from “horizontal 800 pixels×vertical 600 pixels” into “horizontal 720 pixels×vertical 480 pixels”.

Furthermore, in this embodiment, the surveillance image is displayed on the TV monitor. However, the surveillance image may be optionally displayed on a PC (Personal Computer)-use monitor rather than on the TV monitor.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing apparatus, comprising:
a fetcher which repeatedly fetches an object scene image in synchronization with a reference frequency;
a cut-out processor which cuts out an object scene image belonging to a cut-out area, out of the object scene image fetched by said fetcher;
an outputter which performs an output process on the object scene image cut out by said cut-out processor; and
a first changer which changes a size of the cut-out area in a direction opposite to a fluctuating direction of a magnitude of the reference frequency.

2. An image processing apparatus according to claim 1, further comprising a producer which produces the reference frequency based on one of an external synchronization signal that is synchronized with a commercially available alternating power source and an internal synchronization signal, wherein said first changer executes a change process when said producer notices the external synchronization signal.

3. An image processing apparatus according to claim 1, further comprising:
a first requester which requests said producer to select the commercially available alternating power source when the magnitude of the reference frequency belongs to a predetermined range; and
a second requester which requests said producer to select the internal synchronization signal when the magnitude of the reference frequency deviates from the predetermined range.

4. An image processing apparatus according to claim 1, wherein said outputter includes a second changer which changes the size of the object scene image to a size different depending on the size of the cut-out area.

5. An image processing apparatus according to claim 4, wherein said second changer changes the size of the object scene image in a direction opposite to a change direction of the size of the cut-out area.

6. An image processing apparatus according to claim 1, wherein a scanning manner for the object scene image fetched by said fetcher is equivalent to a progressive scanning manner, and said outputter includes a convertor which converts the scanning manner for the object scene image to an interlace scanning manner.

7. An image processing apparatus according to claim 1, further comprising an imager which captures a surveillance area, wherein said fetcher fetches the object scene image outputted from said imager.
